(19) United States
(12) Patent Application Publication
(10) Pub. No.: US 2026/0008920 A1
(43) Pub. Date: Jan. 8, 2026

(54) POLYCARBONATE RESIN COMPOSITION AND MOLDED ARTICLE THEREOF

(71) Applicant: TEIJIN LIMITED, Osaka-shi (JP)

(72) Inventors: Seiichi TANABE, Osaka-shi (JP); Satoshi OGASAWARA, Osaka-shi (JP)

(73) Assignee: TEIJIN LIMITED, Osaka-shi (JP)

(21) Appl. No.: 19/325,848

(22) Filed: Sep. 11, 2025

Related U.S. Application Data
(62) Division of application No. 17/922,866, filed on Nov. 2, 2022.

(30) Foreign Application Priority Data
May 12, 2020 (JP) 2020-083714
Mar. 30, 2021 (JP) 2021-057014

(51) Int. Cl. C08L 69/00

(52) U.S. Cl. CPC C08L 69/00; C08L 2205/03; C08L 2205/06

(57) ABSTRACT

A polycarbonate resin composition having light-guiding performance, characterized by including, per 100 parts by weight of (A) a polycarbonate resin (component A), 0.005 to 0.2 parts by weight of (B) a thioether-based compound (component B). This resin composition is characterized by excellent light-guiding properties with less yellowing during molding and less degradation in a moist heat environment.

### RELATED APPLICATIONS

This application is a divisional application of U.S. application Ser. No. 17/922,866 (filed Nov. 2, 2022), which is a US national stage application of International Application No. PCT/JP2021/015989 (filed Apr. 20, 2021), and claims priority to Japanese Application No. 2021-057014 (filed Mar. 30, 2021) and Japanese Application No. 2020-083714 (filed May 12, 2020), the entireties of which are incorporated herein by reference.

### TECHNICAL FIELD

The present invention relates to a polycarbonate resin composition having light-guiding performance and also to a molded article made thereof. More specifically, it relates to a polycarbonate resin composition that has excellent light-guiding properties, undergoes less yellowing even during molding, undergoes less degradation in a moist heat environment, and is suitable for use in optical elements such as light guide plates, or in display panels, covers for lights, and the like, and also to a molded article made thereof.

### BACKGROUND ART

Light source devices with LEDs as light sources have been attracting attention as next-generation light source devices for their low power consumption and long life. Since the development of blue light emitting diodes in the 1990s, the practical feasibility of white light illumination using LEDs has increased, and commercial products, mainly for local illumination, have rapidly emerged. In addition, also in area light source devices such as displays, LEDs have been increasingly used as light sources because LED light sources are advantageous in that, as compared to colors obtained by passing white light emitted by a cold cathode tube through color filters (red, green, and blue), the color purity of light emitted by RGB three-color LEDs is higher, and the color reproduction range can be greatly expanded.

Meanwhile, because LEDs are point light sources, when a large area is to be illuminated, it is necessary to install a large number of LEDs on the back of the light source device (backlight method), resulting in a disadvantage in that each of them looks like a point light source, that is, unevenness tends to occur. Recently, in order to eliminate such unevenness and also achieve cost reduction, further reduction in power consumption, and also reduction in product thickness, so-called edge-light-type light source devices, in which LEDs are placed on the edge face of the light source device, are increasing.

In an edge-light-type light source device, in order to achieve uniform area luminescence, a light guide that transmits light over long distances is used. However, there is a problem in that in an edge-light-type light source device, darkness increases as the distance from the light source increases. Therefore, as a material for molded bodies having light-guiding properties, characteristics such that light from a light source is less attenuated, that is, light-guiding properties, are required. In the past, among transparent resins, polymethyl methacrylate (hereinafter sometimes referred to as “PMMA”) has been used as the most suitable material. However, PMMA is not necessarily sufficient in terms of impact resistance, thermal stability, and the like, and has a problem in that the use environment for the applications mentioned above is limited. In addition, as LEDs are increasingly used as light sources, light guides have started to also require heat resistance in addition to the above characteristics. Therefore, the technology for improving the light-guiding properties of a polycarbonate resin, which is excellent in terms of heat resistance and impact resistance, has been attracting attention.

As an example of an improvement in the light-guiding properties of polycarbonate, PLT 1 has reported an aromatic polycarbonate resin composition for a light guide plate, incorporating a polycarbonate resin having a viscosity average molecular weight of 13,000 to 15,000 and a specific phosphorus-based stabilizer and a release agent. However, in addition to the strength problem, there is a problem in that the phosphorus-based stabilizer lowers the resistance to moist heat, which limits the applications.

PTLs 2 and 3 have reported an aromatic polycarbonate resin composition for a light guide plate, incorporating a small amount of a specific siloxane compound. However, silicone-based compounds may generate a low-molecular-weight silicone gas under high temperature conditions.

PTL 4 has reported a light guide plate, including a light-scattering layer provided on the front or back surface of a plate-shaped molded body formed using a resin composition composed of polycarbonate and an acrylic resin. PTL 5 has reported an aromatic polycarbonate resin composition composed of an aromatic polycarbonate resin and another thermoplastic resin having a refractive index difference of 0.001 or more from the aromatic polycarbonate resin. However, because an acrylic resin, which is originally incompatible with polycarbonate resins, is added, the amount of addition is limited, and the light-guiding properties may not be sufficiently exhibited.

In PTL 6, a polycarbonate resin composition having added thereto a caprolactone-based polymer and thus having improved optical characteristics and the like is shown, and in PTL 7, a polycarbonate resin composition having added thereto a caprolactone-based polymer and thus having improved moist heat resistance and long-term heat resistance is reported. However, they do not satisfy all of light-guiding properties, hue, and moist heat resistance.

### CITATION LIST

### Patent Literature

PTL 1: JP-A-2007-204737

PTL 2: JP-A-2004-250557

PTL 3: JP-A-2015-157901

PTL 4: JP-A-10-73725

PTL 5: JP-A-2002-60609

PTL 6: JP-A-2007-131679

PTL 7: WO 2016/199783

### SUMMARY OF INVENTION

### Technical Problem

An object of the invention is to provide a polycarbonate resin composition that has excellent light-guiding properties with less yellowing during molding and less degradation in a moist heat environment, and also a molded article made thereof.

### Solution to Problem

The present inventors have conducted extensive research to achieve the above object. As a result, they have found that when a polycarbonate resin is incorporated with a specific proportion of a thioether-based compound, the resulting polycarbonate resin composition achieves the above object, and thus accomplished the invention. In addition, they have also found that when the polycarbonate resin composition is further incorporated with a specific proportion of a caprolactone-based polymer, the resulting polycarbonate resin composition has even better light-guiding properties and suppresses yellowing during molding, and thus accomplished the invention.

That is, according to the invention, the following configurations (1) to (7) are provided.
(1) A polycarbonate resin composition having light-guiding performance, characterized by including, per 100 parts by weight of (A) a polycarbonate resin (component A), 0.005 to 0.2 parts by weight of (B) a thioether-based compound (component B).
(2) The polycarbonate resin composition having light-guiding performance according to item (1) above, wherein the thioether-based compound serving as component B is a thioether-based compound represented by the following formula [1] or [2].

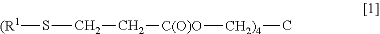

[In formula (1), each R¹, which may be the same or different, is a linear or branched C₄₋₂₀ alkyl group.]

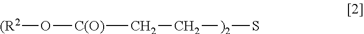

[In formula (2), each R², which may be the same or different, is a linear or branched C₆₋₂₂ alkyl group.]
(3) The polycarbonate resin composition having light-guiding performance according to item (1) or (2) above, wherein the thioether-based compound serving as component B is at least one thioether compound selected from the group consisting of dilauryl-dimyristyl-3,3′-thiodipropionate, 3,3′-thiodipropionate, distearyl-3,3′-thiodipropionate, and pentaerythritol tetrakis(3-laurylthiopropionate).
(4) The polycarbonate resin composition having light-guiding performance according to any one of items (1) to (3) above, further including, per 100 parts by weight of the component A, 0.2 to 1.5 parts by weight of (C) a caprolactone-based polymer having a number average molecular weight of 300 to 8,000 (component C).
(5) The polycarbonate resin composition having light-guiding performance according to item (4) above, wherein the caprolactone polymer serving as component C is at least one caprolactone-based polymer selected from the group consisting of bifunctional polycaprolactone diols, trifunctional polycaprolactone triols, and tetrafunctional polycaprolactone tetraols represented by the following formulas [3] to [5].

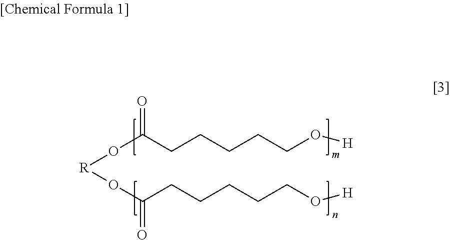

(In the formula, m+n is an integer of 3 or more and 35 or less, and R is C₂H₄, C₂H₄OC₂H₄, or C(CH₃)₂(CH₂)₂.)

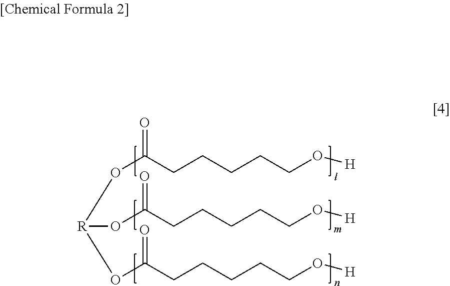

(In the formula, l+m+n is an integer of 3 or more and 35 or less, and R is CH₂CHCH₂, CH₃C(CH₂)₃, or CH₃CH₂C(CH₂)₃.)

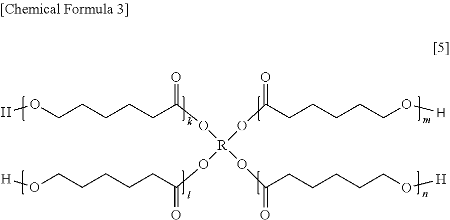

(In the formula, k+l+m+n is an integer of 4 or more and 35 or less, and R is C(CH₂)₄.)
(6) The polycarbonate resin composition having light-guiding performance according to item (4) or (5) above, wherein the caprolactone polymer serving as component C has a number average molecular weight of 500 to 5,000.
(7) A molded article including the polycarbonate resin composition having light-guiding performance according to any one of items (1) to (6) above.

### Advantageous Effects of Invention

The polycarbonate resin composition of the invention is a polycarbonate resin composition including a polycarbonate resin and a thioether-based compound, and exhibits excellent light-guiding properties, hue, and moist heat resistance. The polycarbonate resin composition of the invention has the above effects, and thus is extremely useful for various industrial applications such as the lighting field including LED lights, the OA equipment field, the electrical and electronic equipment field, and the automotive field, and the industrial effects thereof are extremely large. Specific examples include covers for lights, diffusion plates for displays, glass replacement applications, various optical discs such as optical discs and related parts, various housing molded articles such as battery housings, lens barrels, memory cards, speaker cones, disc cartridges, area emitters, mechanical parts for micromachines, molded articles with hinges or molded articles for hinges, light-transmitting/light-guiding buttons, and touch panel parts.

### DESCRIPTION OF EMBODIMENTS

Hereinafter, the invention will be described in detail.

### Component A: Polycarbonate Resin

The polycarbonate resin used as the component A of the invention is usually obtained by reacting a dihydroxy compound with a carbonate precursor using an interfacial polycondensation method or a melt transesterification method, or is alternatively obtained by polymerizing a carbonate prepolymer using a solid-phase transesterification method or by polymerizing a cyclic carbonate compound using a ring-opening polymerization method.

The dihydroxy component used here may be any of those commonly used as dihydroxy components for polycarbonate resins, including bisphenols and aliphatic diols.

As bisphenols, for example, 4,4′-dihydroxybiphenyl, bis(4-hydroxyphenyl)methane, 1,1-bis(4-hydroxyphenyl)ethane, 1,1-bis(4-hydroxyphenyl)-1-phenylethane, 2,2-bis(4-hydroxyphenyl)propane, 2,2-bis(4-hydroxy-3-methylphenyl)propane, 1,1-bis(4-hydroxyphenyl)-3,3,5-trimethylcyclohexane, 2,2-bis(4-hydroxy-3,3′-biphenyl)propane, 2,2-bis(4-hydroxy-3-isopropylphenyl)propane, 2,2-bis(3-t-butyl-4-hydroxyphenyl)propane, 2,2-bis(4-hydroxyphenyl)butane, 2,2-bis(4-hydroxyphenyl)octane, 2,2-bis(3-bromo-4-hydroxyphenyl)propane, 2,2-bis(3,5-dimethyl-4-hydroxyphenyl)propane, 2,2-bis(3-cyclohexyl-4-hydroxyphenyl)propane, 1,1-bis(3-cyclohexyl-4-hydroxyphenyl)cyclohexane, bis(4-hydroxyphenyl)diphenylmethane, 9,9-bis(4-hydroxyphenyl)fluorene, 9,9-bis(4-hydroxy-3-methylphenyl)fluorene, 1,1-bis(4-hydroxyphenyl)cyclohexane, 1,1-bis(4-hydroxyphenyl)cyclopentane, 4,4′-dihydroxydiphenyl ether, 4,4′-dihydroxy-3,3′-dimethyldiphenyl ether, 4,4′-sulfonyldiphenol, 4,4′-dihydroxydiphenylsulfoxide, 4,4′-dihydroxydiphenylsulfide, 2,2′-dimethyl-4,4′-sulfonyldiphenol, 4,4′-dihydroxy-3,3′-dimethyldiphenylsulfoxide, 4,4′-dihydroxy-3,3′-dimethyldiphenylsulfide, 2,2′-diphenyl-4,4′-sulfonyldiphenol, 4,4′-dihydroxy-3,3′-diphenyldiphenylsulfoxide, 4,4′-dihydroxy-3,3′-diphenyldiphenylsulfide, 1,3-bis{2-(4-hydroxyphenyl)propyl}benzene, 1,4-bis{2-(4-hydroxyphenyl)propyl}benzene, 1,4-bis(4-hydroxyphenyl)cyclohexane, 1,3-bis(4-hydroxyphenyl)cyclohexane, 4,8-bis(4-hydroxyphenyl)tricyclo[5.2.1.02,6]decane, 4,4′-(1,3-adamantanediyl)diphenol, 1,3-bis(4-hydroxyphenyl)-5,7-dimethyladamantane, bisphenol compound having a siloxane structure represented by the following formula [6], and the like can be mentioned.

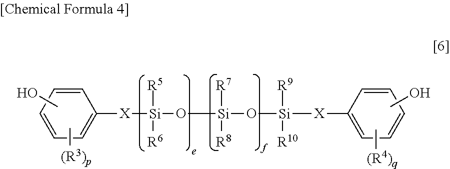

[In the formula, R³ and R⁴ are each independently a hydrogen atom, a halogen atom, a C₁₋₁₀ alkyl group, or a C₁₋₁₀ alkoxy group, R⁵, R⁶, R⁷, R⁸, R⁹, and R¹⁰ are each independently a hydrogen atom, a C₁₋₁₂ alkyl group, or a C₆₋₁₂ substituted or unsubstituted aryl group, p and q are each an integer from 1 to 4, e is a natural number, f is 0 or a natural number, and e+f is a natural number less than 100. X is a C₂₋₈ divalent aliphatic group.]

As aliphatic diols, for example, 2,2-bis(4-hydroxycyclohexyl)-propane, 1,14-tetradecanediol, octaethylene glycol, 1,16-hexadecanediol, 4,4′-bis(2-hydroxyethoxy)biphenyl, bis{(2-hydroxyethoxy) phenyl}methane, 1,1-bis{(2-hydroxyethoxy)phenyl}ethane, 1,1-bis{(2-hydroxyethoxy)phenyl}-1-phenylethane, 2,2-bis{(2-hydroxyethoxy)phenyl}propane, 2,2-bis{(2-hydroxyethoxy)-3-methylphenyl}propane, 1,1-bis(2-hydroxyethoxy)phenyl}-3,3,5-trimethylcyclohexane, 2,2-bis{4-(2-hydroxyethoxy)-3,3′-biphenyl}propane, 2,2-bis{(2-hydroxyethoxy)-3-isopropylphenyl}propane, 2,2-bis{3-t-butyl-4-(2-hydroxyethoxy)phenyl}propane, 2,2-bis{(2-hydroxyethoxy)phenyl}butane, 2,2-bis{(2-hydroxyethoxy)phenyl}-4-methylpentane, 2,2-bis{(2-hydroxyethoxy)phenyl}octane, 1,1-bis{(2-hydroxyethoxy)phenyl}decane, 2,2-bis{3-bromo-4-(2-hydroxyethoxy)phenyl}propane, 2,2-bis{3,5-dimethyl-4-(2-hydroxyethoxy)phenyl}propane, 2,2-bis{3-cyclohexyl-4-(2-hydroxyethoxy)phenyl}propane, 1,1-bis{3-cyclohexyl-4-(2-hydroxyethoxy)phenyl}cyclohexane, bis{(2-hydroxyethoxy)phenyl}diphenylmethane, 9,9-bis{(2-hydroxyethoxy)phenyl}fluorene, 9,9-bis{4-(2-hydroxyethoxy)-3-methylphenyl}fluorene, 1,1-bis{(2-hydroxyethoxy)phenyl}cyclohexane, 1,1-bis{(2-hydroxyethoxy)phenyl}cyclopentane, 4,4′-bis(2-hydroxyethoxy)diphenyl ether, 4,4′-bis(2-hydroxyethoxy)-3,3′-dimethyldiphenyl ether, 1,3-bis[2-{(2-hydroxyethoxy)phenyl}propyl]benzene, 1,4-bis[2-{(2-hydroxyethoxy)phenyl}propyl]benzene, 1,4-bis{(2-hydroxyethoxy)phenyl}cyclohexane, 1,3-bis{(2-hydroxyethoxy)phenyl}cyclohexane, 4,8-bis{(2-hydroxyethoxy)phenyl}tricyclo[5.2.1.02,6]decane, 1,3-bis{(2-hydroxyethoxy)phenyl}-5,7-dimethyladamantane, 3,9-bis(2-hydroxy-1,1-dimethylethyl)-2,4,8,10-tetraoxaspiro(5,5)undecane, 1,4:3,6-dianhydro-D-sorbitol (isosorbide), 1,4:3,6-dianhydro-D-mannitol (isomannide), 1,4:3,6-dianhydro-L-iditol (isoidide), and the like can be mentioned.

Among them, aromatic bisphenols are preferable. In particular, 1,1-bis(4-hydroxyphenyl)-1-phenylethane, 2,2-bis(4-hydroxyphenyl)propane, 2,2-bis(4-hydroxy-3-methylphenyl)propane, 1,1-bis(4-hydroxyphenyl)cyclohexane, 1,1-bis(4-hydroxyphenyl)-3,3,5-trimethylcyclohexane,4,4′-sulfonyldiphenol, 2,2′-dimethyl-4,4′-sulfonyldiphenol, 9,9-bis(4-hydroxy-3-methylphenyl)fluorene, 1,3-bis{2-(4-hydroxyphenyl)propyl}benzene, 1,4-bis{2-(4-hydroxyphenyl)propyl}benzene, and a bisphenol compound represented by the above formula [6] are preferable, and especially 2,2-bis(4-hydroxyphenyl)propane, 1,1-bis(4-hydroxyphenyl)cyclohexane, 4,4′-sulfonyldiphenol, 9,9-bis(4-hydroxy-3-methylphenyl)fluorene, and a bisphenol compound represented by the above formula [6] are preferable. In particular, 2,2-bis(4-hydroxyphenyl)propane, which has excellent strength and good durability, is most preferable. In addition, they may be used alone, and it is also possible to use a combination of two or more kinds.

The polycarbonate resin used as the component A of the invention may also be a branched polycarbonate resin using a branching agent together with the above dihydroxy compound. As trifunctional or higher polyfunctional aromatic compounds used for such a branched polycarbonate resin, phloroglucine, phloroglucide, trisphenols such as 4,6-dimethyl-2,4,6-tris(4-hydroxydiphenyl)heptene-2,2,4,6-trimethyl-2,4,6-tris(4-hydroxyphenyl)heptane, 1,3,5-tris(4-hydroxyphenyl)benzene, 1,1,1-tris(4-hydroxyphenyl)ethane, 1,1,1-tris(3,5-dimethyl-4-hydroxyphenyl)ethane, 26-bis(2-hydroxy-5-methylbenzyl)-4-methylphenol, and 4-{4-[1,1-bis(4-hydroxyphenyl)ethyl]benzene}-α,α-dimethylbenzylphenol, tetra(4-hydroxyphenyl)methane, bis(2,4-dihydroxyphenyl)ketone, and 1,4-bis(4,4-dihydroxytriphenylmethyl)benzene, as well as trimellitic acid, pyromellitic acid, benzophenonetetracarboxylic acid, acid chlorides thereof, and the like, can be mentioned. In particular, 1,1,1-tris(4-hydroxyphenyl)ethane and 1,1,1-tris(3,5-dimethyl-4-hydroxyphenyl)ethane are preferable, and 1,1,1-tris(4-hydroxyphenyl)ethane is particularly preferable.

These polycarbonate resins are produced by a reaction means known per se commonly used for producing an aromatic polycarbonate resin, for example, a method in which an aromatic dihydroxy component is allowed to react with a carbonate precursor such as phosgene or a carbonic acid diester. A basic means for such a production method will be briefly described.

In a reaction using phosgene as a carbonate precursor, for example, the reaction is usually carried out in the presence of an acid binder and a solvent. As an acid binder, for example, an alkali metal hydroxide, such as sodium hydroxide or potassium hydroxide, or an amine compound, such as pyridine, is used. As a solvent, for example, a halogenated hydrocarbon such as methylene chloride or chlorobenzene is used. In addition, it is also possible to use a catalyst such as a tertiary amine or a quaternary ammonium salt, for example, in order to accelerate the reaction. In this case, the reaction temperature is usually 0 to 40° C., and the reaction time is several minutes to 5 hours. A transesterification reaction using a carbonic acid diester as a carbonate precursor is carried out by a method in which a carbonic acid diester is stirred with heating together with a predetermined proportion of an aromatic dihydroxy component in an inert gas atmosphere, and the produced alcohol or phenol is distilled. The reaction temperature depends on the boiling point of the produced alcohol or phenol, etc., but is usually within a range of 120 to 300° C. The reaction is carried out at reduced pressure from the initial stage, and the reaction is completed while distilling the produced alcohol or phenol. In addition, catalysts commonly used in transesterification reactions can also be used in order to accelerate the reaction. As carbonic acid diesters for use in the transesterification reaction, for example, diphenyl carbonate, dinaphthyl carbonate, bis(diphenyl) carbonate, dimethyl carbonate, diethyl carbonate, dibutyl carbonate, and the like can be mentioned. Among them, diphenyl carbonate is particularly preferable.

In the invention, a terminating agent is used in the polymerization reaction. The terminating agent is used to control the molecular weight. In addition, the resulting polycarbonate resin is end-capped, and thus has better thermal stability than those that are not. Examples of such terminating agents are monofunctional phenols represented by the following formulas [7] to [9].

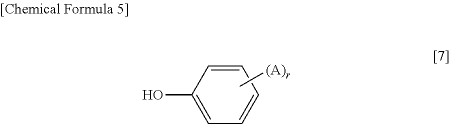

[In formula [7], A is a hydrogen atom, a C₁₋₉ alkyl group, an alkylphenyl group (the alkyl moiety has 1 to 9 carbon atoms), a phenyl group, or a phenylalkyl group (the alkyl moiety has 1 to 9 carbon atoms), and r is an integer from 1 to 5, preferably from 1 to 3].

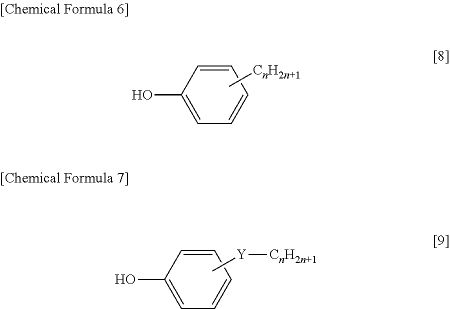

[In formulas [8] and [9], Y is —R—O—, —R—CO—O—, or —R—O—CO—, wherein R represents a single bond or a C₁₋₁₀, preferably C₁₋₅, divalent aliphatic hydrocarbon group, and n represents an integer from 10 to 50.]

As specific examples of monofunctional phenols represented by the above formula [7], for example, phenol, isopropylphenol, p-tert-butylphenol, p-cresol, p-cumylphenol, 2-phenylphenol, 4-phenylphenol, isooctylphenol, and the like can be mentioned.

In addition, monofunctional phenols represented by the above formula [8] or [9] are phenols having a long-chain alkyl group or an aliphatic ester group as a substituent, and are preferably used. This is because when a polycarbonate resin is end-capped using them, they do not only act as a terminating agent or a molecular weight modifier, but also improve the melt flowability of the resin, which does not only facilitate molding processing but also has a lowering effect on the water absorption of the resin.

As substituted phenols of the above formula [8], those wherein n is 10 to 30, particularly 10 to 26, are preferable. As specific examples thereof, for example, decylphenol, dodecylphenol, tetradecylphenol, hexadecylphenol, octadecylphenol, eicosylphenol, docosylphenol, triacontylphenol, and the like can be mentioned.

In addition, as substituted phenols of the above formula [9], compounds wherein Y is —R—COO—, and R is a single bond, are suitable, and those wherein n is 10 to 30, particularly 10 to 26, are preferable. As specific examples thereof, for example, decyl hydroxybenzoate, dodecyl hydroxybenzoate, tetradecyl hydroxybenzoate, hexadecyl hydroxybenzoate, eicosyl hydroxybenzoate, docosyl hydroxybenzoate, and triacontyl hydroxybenzoate can be mentioned.

Among these monofunctional phenols, monofunctional phenols represented by the above formula [7] are preferable, alkyl-substituted or phenylalkyl-substituted phenols are more preferable, and p-tert-butylphenol, p-cumylphenol, and 2-phenylphenol are particularly preferable.

It is desirable that a terminating agent for these monofunctional phenols is introduced into at least 5 mol % of all ends of the obtained polycarbonate resin, preferably at least 10 mol % of the ends. In addition, terminating agents may be used alone, and it is also possible to use a mixture of two or more kinds.

The polycarbonate resin used as the component A of the invention may also be a polyester carbonate copolymerized with an aromatic dicarboxylic acid, such as terephthalic acid, isophthalic acid, naphthalenedicarboxylic acid, or a derivative thereof, without impairing the gist of the invention.

The viscosity average molecular weight of the polycarbonate resin used as the component A of the invention is preferably within a range of 11,500 to 50,000, more preferably within a range of 12,500 to 40,000, still more preferably within a range of 13,500 to 35,000, and most preferably within a range of 15,000 to 30,000. When the molecular weight is more than 50,000, the melt viscosity may become too high, resulting in poor moldability, while when the molecular weight is less than 11,500, problems may occur in mechanical strength. Incidentally, “viscosity average molecular weight” in the invention is determined as follows. First, using an Ostwald viscometer, the specific viscosity calculated by the following equation is obtained from a solution of 0.7 g of a polycarbonate resin dissolved at 20° C. in 100 ml of methylene chloride, and the obtained specific viscosity is inserted into the following equation to determine the viscosity average molecular weight Mv.

$$Specific viscosity ( {η}_{SP} ) = ( t - {t}_{0} ) / {t}_{0}$$

[t₀ is the number of seconds taken for methylene chloride to fall, and t is the number of seconds taken for the sample solution to fall]

$${η}_{SP} / c = [ η ] + 0.45 \times {[ η ]}^{2} c ( wherein [ η ] is intrinsic viscosity )$$

$$[ η ] = 1.23 \times {10}^{- 4} {Mv}^{0.83}$$

$$c = 0.7$$

In the polycarbonate resin used as the component A of the invention, the total Cl (chlorine) content in the resin is preferably 0 to 500 ppm, and more preferably 0 to 350 ppm. When the total Cl content in the polycarbonate resin is within the above range, this results in excellent hue and thermal stability and thus is preferable.

### Component B: Thioether-Based Compound

The thioether-based compound used as the component B of the invention improves the light-guiding performance of the polycarbonate resin, and also improves thermal stability during production or molding processing, leading to improved mechanical characteristics, hue, and molding stability. The thioether-based compound used in the invention is particularly preferably at least one thioether-based compound selected from the group consisting of compounds represented by the following formulas [1] and [2].

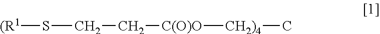

[In the formula, each R¹, which may be the same or different, is a linear or branched C₄₋₂₀ alkyl group.]

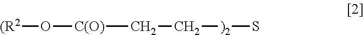

[In the formula, each R², which may be the same or different, is a linear or branched C₆₋₂₂ alkyl group.]

In the thioether-based compound represented by the above formula [1], R¹ is a C₄₋₂₀ alkyl group, preferably a C₁₀₋₁₈ alkyl group. Specifically, pentaerythritol tetrakis(3-laurylthiopropionate), pentaerythritol tetrakis(3-myristylthiopropionate), pentaerythritol tetrakis(3-stearylthiopropionate), and the like can be mentioned. In particular, pentaerythritol tetrakis(3-laurylthiopropionate) and pentaerythritol tetrakis(3-myristylthiopropionate) are preferable, and pentaerythritol tetrakis(3-laurylthiopropionate) is particularly preferable.

In addition, in the thioether-based compound represented by the above formula [2], R² is a C₆₋₂₂ alkyl group, preferably a C₁₀₋₁₈ alkyl group. Specifically, dilauryl-3,3′-thiodipropionate, dimyristyl-3,3′-thiodipropionate, distearyl-3,3′-thiodipropionate, and the like can be mentioned. In particular, dilauryl-3,3′-thiodipropionate and dimyristyl-3,3′-thiodipropionate are preferable, and dimyristyl-3,3′-thiodipropionate is particularly preferable.

The content of the thioether-based compound is within a range of 0.005 to 0.2 parts by weight, preferably within a range of 0.01 to 0.15 parts by weight, and most preferably within a range of 0.02 to 0.1 parts by weight per 100 parts by weight of the polycarbonate resin. When the content is less than 0.005 parts by weight, excellent t light-guiding properties cannot be obtained, and the discoloration-suppressing effect during molding is insufficient; therefore, this is undesirable. In addition, incorporation of an amount exceeding 0.2 parts by weight shows no further improvement of the effect, and the heat resistance is rather reduced; therefore, this is undesirable.

Thioether-based compounds are commercially available as SUMILIZER TP-D (trade name) from Sumitomo Chemical Co., Ltd., and as Irganox PS 802 FL (trade name) from BASF, for example, and are easily accessible.

### Component C: Caprolactone-Based Polymer

The caprolactone-based polymer that is used, if desired, as the component C in the invention improves the light-guiding performance of the polycarbonate resin, and also improves thermal stability during production or molding processing, leading to improved mechanical characteristics, hue, and molding stability.

The caprolactone-based polymer used as the component C is a polymer of a caprolactone, especially s-caprolactone, that is, the repeating unit is (—CH₂—CH₂—CH₂—CH₂—CH₂—C(O)—O—). Some of the hydrogen atoms in the methylene chain of the caprolactone polymer or its repeating unit may be substituted with a halogen atom or a hydrocarbon group. In addition, ends of the polycaprolactone may be terminated by esterification, etherification, or the like.

The polycaprolactone structure is not limited to a polycaprolactone diol like the polymer of ε-caprolactone, and may also be a polycaprolactone triol or a polycaprolactone tetraol, that is, the structure may be bifunctional, trifunctional, or tetrafunctional.

The caprolactone-based polymer used in the invention is, specifically, preferably at least one caprolactone-based polymer selected from the group consisting of bifunctional polycaprolactone diols, trifunctional polycaprolactone triols, and tetrafunctional caprolactone tetraols represented by the following formulas [3] to [5].

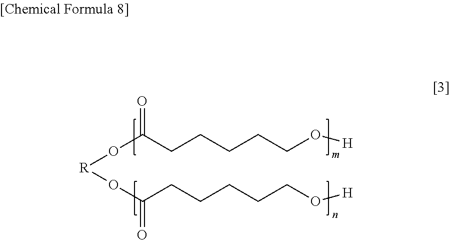

(In the formula, m+n is an integer of 3 or more and 35 or less, and R is C₂H₄, C₂H₄OC₂H₄, or C(CH₃)₂(CH₂)₂.)

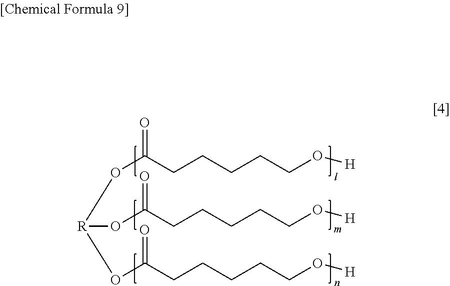

(In the formula, l+m+n is an integer of 3 or more and 35 or less, and R is CH₂CHCH₂, CH₃C(CH₂)₃, or CH₃CH₂C(CH₂)₃.)

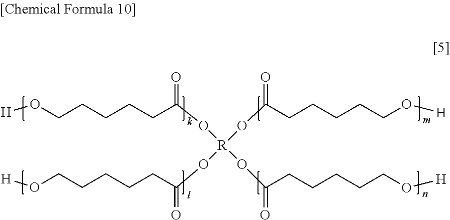

(In the formula, k+l+m+n is an integer of 4 or more and 35 or less, and R is C(CH₂)₄.)

The molecular weight of the caprolactone-based polymer used in the invention is, as the polystyrene-equivalent number average molecular weight determined by GPC, within a range of 300 to 8,000, preferably within a range of 400 to 6,000, more preferably within a range of 500 to 5,000, still more preferably within a range of 700 to 4,000, particularly preferably within a range of 800 to 3,000, and most preferably within a range of 1,000 to 2,000. In the case where the number average molecular weight of the caprolactone-based polymer is 8,000 or less, dispersibility in the polycarbonate resin is excellent, and the enhancing effect on light-guiding properties is large, while in the case of 300 or more, the heat resistance of the polycarbonate resin is not adversely affected.

The content of the caprolactone-based polymer is preferably within a range of 0.2 to 1.5 parts by weight, more preferably within a range of 0.3 to 1.3 parts by weight, still more preferably within a range of 0.4 to 1.2 parts by weight, and particularly preferably within a range of 0.5 to 1.0 parts by weight per 100 parts by weight of the polycarbonate resin. In the case where the content is 0.2 parts by weight or more, excellent light-guiding properties are obtained, while in the case of 1.5 parts by weight or less, the heat resistance and mechanical strength are not adversely affected.

### Other Components

The polycarbonate resin composition of the invention may incorporate other resins and fillers as long as they do not impair transparency, light-guiding properties, and the like. However, many of other resins and fillers interfere with transparency, and thus the kinds and amounts thereof should be selected considering this point.

In the polycarbonate resin composition of the invention, in order to improve its thermal stability, design features, and the like while considering the above point, additives used for such improvements are advantageously used. Hereinafter, these additives will be specifically described.

### (I) Heat Stabilizer

The polycarbonate resin composition of the invention can incorporate known various heat stabilizers. Specifically, phosphorus-based antioxidants, phenol-based antioxidants, and the like can be mentioned.

Specific examples of such phosphorus-based antioxidants include phosphorous acid (phosphites), phosphonites, phosphinites, phosphines, phosphoric acid (phosphates), phosphonates, phosphinates, and phosphine oxides. In particular, phosphites, phosphonites, phosphines, phosphonates, and phosphates are preferably used. Specifically, as phosphite compounds, for example, trimethyl phosphite, triethyl phosphite, tripropyl phosphite, triisopropyl phosphite, tributyl phosphite, triphenyl phosphite, tris(nonylphenyl) phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, 2,2-methylenebis(4,6-di-tert-butylphenyl)octyl phosphite, tris(diethylphenyl) phosphite, tris(di-iso-propylphenyl) phosphite, tris(di-n-butylphenyl) phosphite, tris(2,4-di-tert-butylphenyl) phosphite, tris(2,6-di-tert-butylphenyl) phosphite, distearyl pentaerythritol diphosphite, bis(2,4-di-tert-butylphenyl)pentaerythritol diphosphite, bis(2,6-di-tert-butyl-4-methylphenyl)pentaerythritol diphosphite, bis(2,6-di-tert-butyl-4-ethylphenyl)pentaerythritol diphosphite, phenyl bisphenol A pentaerythritol diphosphite, bis(nonylphenyl)pentaerythritol diphosphite, dicyclohexyl pentaerythritol diphosphite, and the like can be mentioned. Further, as other phosphite compounds, those that react with dihydric phenols and have a cyclic structure can also be used. For example, 2,2′-methylenebis(4,6-di-tert-butylphenyl)(2,4-di-tert-butylphenyl) phosphite, 2,2′-methylenebis(4,6-di-tert-butylphenyl)(2-tert-butyl-4-methylphenyl) phosphite, 2,2′-methylenebis(4-methyl-6-tert-butylphenyl)(2-tert-butyl-4-methylphenyl) phosphite, 2,2′-ethylidenebis(4-methyl-6-tert-butylphenyl)(2-tert-butyl-4-methylphenyl) phosphite, and the like can be mentioned.

As phosphonite compounds, tetrakis(2,4-di-tert-butylphenyl)-4,4′-biphenylene diphosphonite, tetrakis(2,4-di-tert-butylphenyl)-4,3′-biphenylene diphosphonite, tetrakis(2,4-di-tert-butylphenyl)-3,3′-biphenylene diphosphonite, tetrakis(2,6-di-tert-butylphenyl)-4,4′-biphenylene diphosphonite, tetrakis(2,6-di-tert-butylphenyl)-4,3′-biphenylene diphosphonite, tetrakis(2,6-di-tert-butylphenyl)-3,3′-biphenylene diphosphonite, bis(2,4-di-tert-butylphenyl)-4-phenyl-phenyl phosphonite, bis(2,4-di-tert-butylphenyl)-3-phenyl-phenyl phosphonite, bis(2,6-di-n-butylphenyl)-3-phenyl-phenyl phosphonite, bis(2,6-di-tert-butylphenyl)-4-phenyl-phenyl phosphonite, bis(2,6-di-tert-butylphenyl)-3-phenyl-phenyl phosphonite, and the like can be mentioned. Tetrakis(di-tert-butylphenyl)-biphenylene diphosphonite and bis(di-tert-butylphenyl)-phenyl-phenyl phosphonite are preferable, and tetrakis(2,4-di-tert-butylphenyl)-biphenylene diphosphonite and bis(2,4-di-tert-butylphenyl)-phenyl-phenyl phosphonite are more preferable. It is possible and preferable that such a phosphonite compound is used together with a phosphite compound having an aryl group with two or more alkyl groups being substituted as described above.

Examples of phosphine compounds include triethyl phosphine, tripropyl phosphine, tributyl phosphine, trioctyl phosphine, triamyl phosphine, dimethylphenyl phosphine, dibutylphenyl phosphine, diphenylmethyl phosphine, diphenyloctyl phosphine, triphenyl phosphine, tri-p-tolyl phosphine, trinaphthyl phosphine, and diphenylbenzyl phosphine. A particularly preferred phosphine compound is triphenyl phosphine.

As phosphonate compounds, dimethyl benzenephosphonate, diethyl benzenephosphonate, dipropyl benzenephosphonate, and the like can be mentioned.

As phosphate compounds, tributyl phosphate, trimethyl phosphate, tricresyl phosphate, triphenyl phosphate, trichlorophenyl phosphate, triethyl phosphate, diphenyl cresyl phosphate, diphenyl monoorthoxenyl phosphate, tributoxyethyl phosphate, dibutyl phosphate, dioctyl phosphate, diisopropyl phosphate, and the like can be mentioned, and triphenyl phosphate and trimethyl phosphate are preferable.

As specific examples of phenol-based antioxidants, for example, vitamin E, n-octadecyl-β-(4′-hydroxy-3′,5′-di-tert-butylphenyl)propionate, 2-tert-butyl-6-(3′-tert-butyl-5′-methyl-2′-hydroxybenzyl)-4-methylphenyl acrylate, 2,6-di-tert-butyl-4-(N, N-dimethylaminomethyl)phenol, 3,5-di-tert-butyl-4-hydroxybenzylphosphonate diethylester, 2,2′-methylenebis(4-methyl-6-tert-butylphenol), 2,2′-methylenebis(4-ethyl-6-tert-butylphenol), 4,4′-methylenebis(2,6-di-tert-butylphenol), 2,2′-methylenebis(4-methyl-6-cyclohexylphenol), 2,2′-dimethylene-bis(6-α-methyl-benzyl-p-cresol), 2,2′-ethylidene-bis(4,6-di-tert-butylphenol), 2,2′-butylidene-bis(4-methyl-6-tert-butylphenol), 4,4′-butylidenebis(3-methyl-6-tert-butylphenol), triethylene glycol-N-bis-3-(3-tert-butyl-4-hydroxy-5-methylphenyl)propionate, 1,6-hexanediol bis[3-(3,5-di-tert-butyl-4-hydroxyphenyl)propionate, bis[2-tert-butyl-4-methyl-6-(3-tert-butyl-5-methyl-2-hydroxybenzyl)phenyl]terephthalate, 3,9-bis{2-[3-(3-tert-butyl-4-hydroxy-5-methylphenyl)propionyloxy]-1,1,-dimethylethyl}-2,4,8,10-tetraoxaspiro[5,5]undecane, 4,4′-thiobis(6-tert- butyl-m-cresol), 4,4′-thiobis(3-methyl-6-tert-butylphenol), 2,2′-thiobis(4-methyl-6-tert-butylphenol), bis(3,5-di-tert-butyl-4-hydroxybenzyl)sulfide, 4,4′-di-thiobis(2,6-di-tert-butylphenol), 4,4′-tri-thiobis(2,6-di-tert-butylphenol), 2,4-bis(n-octylthio)-6-(4-hydroxy-3′,5′-di-tert-butylanilino)-1,3,5-triazine, N,N′-hexamethylenebis-(3,5-di-tert-butyl-4-hydroxyhydrocinnamide), N,N′-bis[3-(3,5-di-tert-butyl-4-hydroxyphenyl)propionyl]hydrazine, 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, tris(3,5-di-tert-butyl-4-hydroxyphenyl)isocyanurate, tris(3,5-di-tert-butyl-4-hydroxybenzyl)isocyanurate, 1,3,5-tris(4-tert-butyl-3-hydroxy-2,6-dimethylbenzyl)isocyanurate, 1,3,5-tris 2[3(3,5-di-tert-butyl-4-hydroxyphenyl)propionyloxy]ethylisocyanurate, tetrakis[methylene-3-(3′,5′-di-tert-butyl-4-hydroxyphenyl)propionate]methane, and the like can be mentioned, and can be preferably used.

In particular, n-octadecyl-β-(4′-hydroxy-3′,5′-di-tert-butylphenyl)propionate, 2-tert-butyl-6-(3′-tert-butyl-5′-methyl-2′-hydroxybenzyl)-4-methylphenyl acrylate, 3,9-bis{2-[3-(3-tert-butyl-4-hydroxy-5-methylphenyl)propionyloxy]-1,1,-dimethylethyl}-2,4,8,10-tetraoxaspiro[5,5]undecane, and tetrakis[methylene-3-(3′,5′-di-tert-butyl-4-hydroxyphenyl)propionate]methane are preferable, and n-octadecyl-β-(4′-hydroxy-3′,5′-di-tert-butylphenyl)propionate is still more preferable.

The phosphorus-based antioxidants and phenol-based antioxidants mentioned above may each be used alone, and it is also possible to use two or more kinds together. The phosphorus-based antioxidant content and phenol-based antioxidant content are each preferably 0.0001 to 1 part by weight per 100 parts by weight of the component A. The content is more preferably 0.0005 to 0.5 parts by weight, and still more preferably 0.001 to 0.2 parts by weight.

Incidentally, with respect to phosphorus-based antioxidants, especially phosphite-based antioxidants, as the amount of antioxidant incorporated increases, the moist heat resistance of the polycarbonate resin decreases. Therefore, the amount of incorporation is preferably less than 0.02 parts by weight, more preferably 0.015 parts by weight or less, still more preferably 0.01 parts by weight or less, particularly preferably 0.005 parts by weight or less, and most preferably 0.001 parts by weight or less. Further, it is preferable to incorporate substantially no such antioxidant.

### (II) Release Agent

The polycarbonate resin composition of the invention can incorporate a release agent as required. As such release agents, those known per se can be used. For example, saturated fatty acid esters, unsaturated fatty acid esters, polyolefin-based waxes (polyethylene waxes and 1-alkene polymers can be mentioned; these waxes modified with a functional group-containing compound, such as acid-modified ones, are also usable), silicone compounds, fluorine compounds, paraffin wax, beeswax, and the like can be mentioned. Among them, saturated fatty acid esters, linear or cyclic polydimethylsiloxane oils, polymethylphenyl silicone oils, and fluorine oils are preferable. As particularly preferred release agents, saturated fatty acid esters can be mentioned, and, for example, monoglycerides such as stearic acid monoglyceride, polyglycerin fatty acid esters such as decaglycerin decastearate and decaglycerin tetrastearate, lower fatty acid esters such as stearic acid stearate, higher fatty acid esters such as sebacic acid behenate, and erythritol esters such as pentaerythritol tetrastearate are used. The content of such a release agent is preferably 0.01 to 1 part by weight per 100 parts by weight of the component A.

### (III) UV Absorber

The polycarbonate resin composition of the invention can incorporate a UV absorber as required. As such UV absorbers, for example, benzophenone-based UV absorbers as represented by 2,4-dihydroxybenzophenone, 2-hydroxy-4-methoxybenzophenone, 2-hydroxy-4-n-octoxybenzophenone, 2-hydroxy-4-n-dodecyloxybenzophenone, 2-hydroxy-4-benzyloxybenzophenone, 2,2′-dihydroxy-4-methoxybenzophenone, 2-hydroxy-4-methoxy-2′-carboxybenzophenone, 2-hydroxy-4-methoxy-5-sulfoxybenzophenone, 2,2′-dihydroxy-4,4′-dimethoxybenzophenone, 2,2′,4,4′-tetrahydroxybenzophenone, 2,2′-dihydroxy-4,4′-dimethoxy-5-sodium sulfoxybenzophenone, bis(5-benzoyl-4-hydroxy-2-methoxyphenyl)methane, and the like can be mentioned.

In addition, as UV absorbers, for example, benzotriazole-based UV absorbers as represented by 2-(2′-hydroxy-5′-methylphenyl)benzotriazole, 2-(2′-hydroxy-5′-tert-butylphenyl)benzotriazole, 2-(2′-hydroxy-5′-tert-octylphenyl)benzotriazole, 2-(2′-hydroxy-3′,5′-di-tert-butylphenyl)benzotriazole, 2-(2′-hydroxy-3′,5′-di-tert-amylphenyl)benzotriazole, 2-(2′-hydroxy-3′-dodecyl-5′-methylphenyl)benzotriazole, 2-(2′-hydroxy-3′,5′-bis(α,α′-dimethylbenzyl)phenyl benzotriazole, 2-[2′-hydroxy-3′-(3″,4″,5″,6″-tetraphthalimidomethyl)-5′-methylphenyl]benzotriazole, 2-(2′-hydroxy-3′-tert-butyl-5′-methylphenyl)-5-chlorobenzotriazole, 2-(2′-hydroxy-3′,5′-di-tert-butylphenyl)-5-chlorobenzotriazole, 2,2′methylenebis[4-(1,1,3,3-tetramethylbutyl)-6-(2H-benzotriazol-2-yl)phenol], and condensates of methyl-3-[3-tert-butyl-5-(2H-benzotriazol-2-yl)-4-hydroxyphenyl propionate and polyethylene glycol can be mentioned.

Further, as UV absorbers, for example, hydroxyphenyltriazine-based compounds as represented by 2-(4,6-diphenyl-1,3,5-triazin-2-yl)-5-hexyloxy-phenol, 2-(4,6-bis-(2,4-dimethylphenyl-1,3,5-triazin-2-yl)-5-hexyloxy-phenol, and the like, and malonic acid ester-based compounds as represented by Hostavin PR-25 manufactured by Clariant Japan, Hostavin B-CAP manufactured by Clariant Japan, and the like, which are 2-(1-arylalkylidene)malonic acid esters, can be mentioned.

The UV absorber content is preferably 0.01 to 5 parts by weight, more preferably 0.02 to 1 part by weight, per 100 parts by weight of the component A.

### (IV) Light Stabilizer

The polycarbonate resin composition of the invention can incorporate a light stabilizer as required. As such light stabilizers, for example, hindered represented by bis(2,2,6,6-tetramethyl-4-piperidyl)sebacate, bis(1,2,2,6,6-pentamethyl-4-piperidyl)sebacate, bis(1,2,2,6,6-pentamethy-4-piperidyl)-2-(3,5-di-tert-butyl-4-hydroxybenzyl)-2n-butylmalonate, condensates of 1,2,3,4-butanecarboxylic acid, 2,2,6,6-tetramethyl-4-piperidinol, and tridecyl alcohol, condensates of 1,2,3,4-butanedicarboxylic acid, 1,2,2,6,6-pentamethyl-4-piperidinol, and tridecyl alcohol, tetrakis(2,2,6,6-tetramethyl-4-piperidyl)-1,2,3,4-butanetetracarboxylate, tetrakis(1,2,2,6,6-pentamethyl-4-piperidyl)-1,2,3,4-butanetetracarboxylate, poly{[6-(1,1,3,3-tetramethylbutyl)amino-1,3,5-triazine-2,4-diyl][(2,2,6,6-tetramethylpiperidyl)imino]hexamethylene[(2,2,6,6-tetramethylpiperidyl)imino]}, poly{[6-morpholino-s-triazine-2,4-diyl][(2,2,6,6-tetramethylpiperidyl)imino]hexamethylene[(2,2,6,6-tetramethylpiperidyl)imino]}, condensates of 1,2,3,4-butanetetracarboxylic acid, 2,2,6,6-tetramethyl-4-piperidinol, and β,62 ,62′,β′-tetramethyl-3,9-(2,4,8,10-tetraoxaspiro[5,5]undecane)diethanol, condensates of N,N′-bis(3-aminopropyl)ethylenediamine and 2,4-bis[N-butyl-N-(1,2,2,6,6-pentamethyl-4-piperidyl)amino]-chloro-1,3,5-triazine, condensates of 1,2,3,4-butanetetracarboxylic acid, 1,2,2,6,6-pentamethyl-4-piperidinol, and β,β,β′,β′-tetramethyl-3,9-(2,4,8,10-tetraoxaspiro[5,5]undecane)diethanol, and polymethylpropyl 3-oxy-[4-(2,2,6,6-tetramethyl)piperidinyl]siloxane can be mentioned. The light stabilizer content is preferably 0.01 to 5 parts by weight, more preferably 0.02 to 1 part by weight, per 100 parts by weight of the component A.

### (V) Bluing Agent

The polycarbonate resin composition of the invention can incorporate a bluing agent in order to counteract yellowness due to UV absorbers or the like. As bluing agents, those commonly used for polycarbonate resin can be used without any particular inconvenience. Generally, anthraquinone-based dyes are easy to obtain and preferable. As specific bluing agents, for example, general name Solvent Violet 13 [CA. No. (Color Index No.) 60725; trade names “MACROLEX Violet B” manufactured by Bayer, “Diaresin Blue G” manufactured by Mitsubishi Chemical Corporation, and “SUMIPLAST Violet B” manufactured by Sumitomo Chemical Co., Ltd.], general name Solvent Violet 31 [CA. No. 68210; trade name “Diaresin Violet D” manufactured by Mitsubishi Chemical Corporation], general name Solvent Violet 33 [CA. No. 60725; trade name “Diaresin Blue J” manufactured by Mitsubishi Chemical Corporation], general name Solvent Blue 94 [CA. No. 61500; trade name “Diaresin Blue N” manufactured by Mitsubishi Chemical Corporation], general name Solvent Violet 36 [CA. No. 68210; trade name “MACROLEX Violet 3R” manufactured by Bayer”], general name Solvent Blue 97 [trade name “MACROLEX Blue RR” manufactured by Bayer], general name Solvent Blue 45 [CA. No. 61110; trade name “Telazol Blue RLS” manufactured by Sandoz K.K.], and the like can be mentioned, and, in particular, MACROLEX Blue RR, MACROLEX Violet B, and Telazol Blue RLS are preferable. The bluing agent content is preferably 0.000005 to 0.001 parts by weight, more preferably 0.00001 to 0.0001 parts by weight, per 100 parts by weight of the component A.

### (VI) Fluorescent Brightener

As fluorescent brighteners in the polycarbonate resin composition of the invention, those used for improving the color tone of a resin or the like to make the color white or bluish white can be used without any particular limitation, and, for example, stilbene-based, benzimidazole-based, benzoxazole-based, naphthalimide-based, rhodamine-based, coumarin-based, and oxazine-based compounds and the like can be mentioned. Specifically, for example, CI Fluorescent Brightener 219:1, EASTOBRITE OB-1 manufactured by Eastman Chemical Co., “Hakkol PSR” manufactured by Hakkol Chemical Co., Ltd. and the like can be mentioned. Here, a fluorescent brightener acts to absorb energy in the UV portion of light and emit this energy into the visible region. The fluorescent brightener content is preferably 0.001 to 0.1 parts by weight, more preferably 0.001 to 0.05 parts by weight, per 100 parts by weight of the component A.

### (VII) Epoxy Compound

The polycarbonate resin composition of the invention can incorporate an epoxy compound as required. Such an epoxy compound is incorporated for the purpose of suppressing mold corrosion, and basically all those that have an epoxy functional group are applicable. As specific examples of preferred epoxy compounds, 3,4-epoxycyclohexylmethyl-3′,4′-epoxycyclohexylcarboxylate, 1,2-epoxy-4-(2-oxiranyl)cyclohexane adducts of 2,2-bis(hydroxymethyl)-1-butanol, copolymers of methyl methacrylate and glycidyl methacrylate, copolymers of styrene and glycidyl methacrylate, and the like can be mentioned. The amount of such an epoxy compound to be added is preferably 0.003 to 0.2 parts by weight, more preferably 0.004 to 0.15 parts by weight, and still more preferably 0.005 to 0.1 parts by weight, per 100 parts by weight of the component A.

### (VIII) Organic Metal Salt

The polycarbonate resin composition of the invention can incorporate an organic metal salt compound. Such an organic metal salt is incorporated for the purpose of imparting flame retardancy, and is preferably an alkali (earth) metal salt of a C₁₋₅₀, preferably C₁₋₄₀, organic acid, and more preferably an organic sulfonic acid alkali (earth) metal salt. Such organic sulfonic acid alkali (earth) metal salts include metal salts of fluorine-substituted alkylsulfonic acids such as a metal salt of a C₁₋₁₀, preferably C₂₋₈, perfluoroalkylsulfonic acid with an alkali metal or alkaline earth metal, and also a metal salt of a C₇₋₅₀, preferably C₇₋₄₀, aromatic sulfonic acid with an alkali metal or alkaline earth metal. As metal salt-forming alkali metals, lithium, sodium, potassium, rubidium, and cesium can be mentioned, and as alkaline earth metals, beryllium, magnesium, calcium, strontium, and barium can be mentioned. Alkali metals are more preferable. Among such alkali metals, in the case where the demand for transparency is higher, rubidium and cesium, which have larger ionic radii, are preferable. However, they are not versatile and also difficult to refine, and thus may consequently be disadvantageous in terms of cost. Meanwhile, metals with smaller ionic radii, such as lithium and sodium, may be rather disadvantageous in terms of flame retardancy. Alkali metals in sulfonic acid alkali metal salts can be properly used considering these factors, but in all respects, sulfonic acid potassium salts, which have an excellent balance of characteristics, are most preferable. It is also possible to use such a potassium salt together with a sulfonic acid alkali metal salt composed of another alkali metal.

As specific examples of perfluoroalkylsulfonic acid alkali metal salts, potassium trifluoromethanesulfonate, potassium perfluorobutanesulfonate, potassium perfluorohexanesulfonate, potassium perfluorooctanesulfonate, sodium pentafluoroethanesulfonate, sodium perfluorobutanesulfonate, sodium perfluorooctanesulfonate, lithium trifluoromethanesulfonate, lithium perfluorobutanesulfonate, lithium perfluoroheptanesulfonate, cesium trifluoromethanesulfonate, cesium perfluorobutanesulfonate, cesium perfluorooctanesulfonate, cesium perfluorohexanesulfonate, rubidium perfluorobutanesulfonate, rubidium perfluorohexanesulfonate, and the like can be mentioned. They can be used alone, and it is also possible to use two or more kinds together. Here, the number of carbon atoms in the perfluoroalkyl group is preferably within a range of 1 to 18, more preferably within a range of 1 to 10, and still more preferably within a range of 1 to 8. Among them, potassium perfluorobutanesulfonate is particularly preferable. A perfluoroalkylsulfonic acid alkali (earth) metal salt composed of an alkali metal is usually contaminated with not a small amount of fluoride ions. The presence of such fluoride ions can be a factor that decreases the flame retardancy, and thus is preferably reduced as much as possible. The proportion of such fluoride ions can be measured by ion chromatography. The content of fluoride ions is preferably 100 ppm or less, more preferably 40 ppm or less, and particularly preferably 10 ppm or less. In addition, in terms of production efficiency, the content is preferably 0.2 ppm or more. Such a perfluoroalkylsulfonic acid alkali (earth) metal salt having a reduced amount of fluoride ions can be produced using a known production method as the production method, and also using a method in which the amount of fluoride ions contained in the raw materials for the production of a fluorine-containing organic metal salt is reduced, a method in which hydrogen fluoride and the like resulting from the reaction are removed using the gas generated during the reaction or by heating, a method in which the amount of fluoride ions is reduced using a purification method such as recrystallization or reprecipitation during the production of a fluorine-containing organic metal salt, or the like. In particular, organic metal salt-based flame retardants are relatively soluble in water. Therefore, production is preferably performed through steps in which the salt is dissolved at a temperature higher than room temperature using an ion-exchanged water, especially water that satisfies an electrical resistance value of 18 MΩ·cm or more, that is, an electrical conductivity of about 0.55 μS/cm or less, washed, then cooled, and recrystallized.

As specific examples of aromatic sulfonic acid alkali (earth) metal salts, for example, disodium diphenylsulfide-4,4′-disulfonate, dipotassium diphenylsulfide-4,4′-disulfonate, potassium 5-sulfoisophthalate, sodium 5-sulfoisophthalate, polysodium polyethylene terephthalate polysulfonate, calcium 1-methoxynaphthalene-4-sulfonate, disodium 4-dodecylphenyl ether disulfonate, polysodium poly(2,6-dimethylphenyleneoxide)polysulfonate, polysodium poly (1,3-phenyleneoxide)polysulfonate, polysodium poly(1,4-phenyleneoxide)polysulfonate, polypotassium poly(2,6-diphenylphenyleneoxide)polysulfonate, lithium poly (2-fluoro-6-butylphenyleneoxide)polysulfonate, potassium sulfonate of benzenesulfonate, sodium benzenesulfonate, strontium benzenesulfonate, magnesium benzenesulfonate, dipotassium p-benzenedisulfonate, dipotassium naphthalene-2,6-disulfonate, calcium biphenyl-3,3′-disulfonate, sodium diphenylsulfone-3-sulfonate, potassium diphenylsulfone-3-sulfonate, dipotassium diphenylsulfone-3,3′-disulfonate, dipotassium diphenylsulfone-3,4′-disulfonate, sodium α,α,α-trifluoroacetophenone-4-sulfonate, dipotassium benzophenone-3,3′-disulfonate, disodium thiophene-2,5-disulfonate, dipotassium thiophene-2,5-disulfonate, calcium thiophene-2,5-disulfonate, sodium benzothiophenesulfonate, potassium diphenylsulfoxide-4-sulfonate, formalin condensates of sodium naphthalenesulfonate, formalin condensates of sodium anthracenesulfonate, and the like can be mentioned. Among these aromatic sulfonic acid alkali (earth) metal salts, potassium salts are particularly preferable. Among these aromatic sulfonic acid alkali (earth) metal salts, potassium diphenylsulfone-3-sulfonate and dipotassium diphenylsulfone-3,3-disulfonate are preferable, and mixtures thereof (weight ratio of the former to the latter is 15/85 to 30/70) are particularly preferable.

Preferred examples of organic metal salts other than sulfonic acid alkali (earth) metal salts are alkali (earth) metal salts of sulfuric acid esters, alkali (earth) metal salts of aromatic sulfonamides, and the like. As alkali (earth) metal salts of sulfuric acid esters, in particular, alkali (earth) metal salts of sulfuric acid esters of monohydric and/or polyhydric alcohols can be mentioned. As such sulfuric acid esters of monohydric and/or polyhydric alcohols, methyl sulfate, ethyl sulfate, lauryl sulfate, hexadecyl sulfate, sulfuric acid esters of polyoxyethylene alkylphenyl ethers, mono-, di-, tri-, and tetra-sulfuric acid esters of pentaerythritol, sulfuric acid esters of lauric acid monoglyceride, sulfuric acid esters of palmitic acid monoglyceride, sulfuric acid esters of stearic acid monoglyceride, and the like can be mentioned. As preferred alkali (earth) metal salts of such sulfuric acid esters, alkali (earth) metal salts of lauryl sulfate can be mentioned. As alkali (earth) metal salts of aromatic sulfonamides, for example, saccharin, alkali (earth) metal salts of N-(p-tolylsulfonyl)-p-toluenesulfimide, N-(N′-benzylaminocarbonyl)sulfanilimide, and N-(phenylcarboxyl)sulfanilimide, and the like can be mentioned. The organic metal salt content is preferably 0.001 to 1 part by weight, more preferably 0.005 to 0.5 parts by weight, still more preferably 0.01 to 0.3 parts by weight, and particularly preferably 0.03 to 0.15 parts by weight, per 100 parts by weight of the component A.

### (IX) Others

In addition to the above, the resin composition of the invention can incorporate additives known per se for imparting various functions to the molded article and improving its characteristics, as long as they do not impair the object of the invention. As such additives, reinforcing fillers, sliding agents (e.g., PTFE particles), colorants, fluorescent dyes, inorganic phosphors (e.g. phosphors whose mother crystals are aluminates), antistatic agents, crystal nucleating agents, inorganic and organic antibacterial agents, photocatalytic antifouling agents (e.g., microparticle titanium oxide, microparticle zinc oxide), light diffusing agents, flow modifiers, radical generators, IR absorbers (heat absorbers), photochromic agents, and the like can be mentioned.

### Production of Polycarbonate Resin Composition

Any method can be employed to produce the polycarbonate resin composition of the invention. For example, a method in which the component A, the component B, and optionally other components are each thoroughly mixed using a premixing means such as a V-shaped blender, a Henschel mixer, a mechanochemical apparatus, an extrusion mixer, or the like, subsequently granulated using an extrusion granulator, a briquetting machine, or the like as required, then melt-kneaded using a melt kneader as represented by a vented twin-screw extruder, and pelletized using a pelletizer or the like equipment, can be mentioned. As alternative methods, a method in which the component A, the component B, optionally and other components are each independently fed to a melt kneader as represented by a vented twin-screw extruder, a method in which the component A and some of other components are pre-mixed and then fed to a melt kneader independently of the rest of components, a method in which the component B is diluted and mixed with water or an organic solvent and then fed to a melt kneader, or the diluted mixture is pre-mixed with other components and then fed to a melt kneader, and the like can also be mentioned. Incidentally, when some of the components to be incorporated are liquid, a so-called liquid injection apparatus or liquid addition apparatus can be used for feeding to the melt kneader.

### Production of Molded Article

Any method can be employed to produce a molded article made of the polycarbonate resin composition of the invention. For example, the polycarbonate resin composition is kneaded using an extruder, a Banbury mixer, a roll, or the like, and then molded by a conventionally known method such as injection molding, extrusion molding, or compression molding, whereby the molded article can be obtained. In addition, it is also possible that a light source is provided on at least one side surface of a molded plate obtained by molding the composition into a plate shape, and a reflection plate is installed on one side of the molded plate, thereby forming an area light source device. As light sources for such a molded plate or area light source device, in addition to fluorescent lamps, self-luminous objects such as cold cathode tubes, LEDs, laser diodes, and organic ELs can be used. The molded plate, area light source device, and the like, which are molded articles obtained in the invention, are used for mobile phones, mobile terminals, cameras, clocks, laptop computers, displays, lights, signals, automobile lamps, display parts of home appliances and optical equipment, and the like.

The best mode of the invention presently contemplated by the present inventors is an aggregation of the preferred ranges of requirements described above, and, as examples, representative examples thereof will be described in the following examples. Needless to say, the invention is not limited to these modes.

### EXAMPLE

Hereinafter, the invention will be described in further detail with reference to examples, but the invention is not limited to these examples.

Incidentally, the details of each component used and the evaluation are as follows.

### Mode 1

### Component A

A-1: Bisphenol A aromatic polycarbonate resin (manufactured by Teijin Limited: CM-1000, viscosity average molecular weight=15,400)
A-2: Bisphenol A aromatic polycarbonate resin (manufactured by Teijin Limited: L-1225WX, viscosity average molecular weight=19,900)

### Component B

B-1: Pentaerythritol tetrakis(3-laurylthiopropionate) (manufactured by Sumitomo Chemical Co., Ltd.: SUMILIZER TP-D)
B-2: Dimyristyl-3,3-thiodipropionate (manufactured by BASF: Irganox PS 802 FL)

### Other Components

### Antioxidant

D-1: Bis(2,6-di-tert-butyl-4-methylphenyl) pentaerythritol diphosphite (manufactured by ADEKA CORPORATION: ADK-STAB PEP-36)
D-2: Tris(2,4-di-tert-butylphenyl) phosphite (manufactured by BASF: Irgafos 168)
D-3: Hindered phenol-based antioxidant (manufactured by BASF: Irganox 1076)

### Release Agent

E: Glycerin monostearate (manufactured by Riken Vitamin Co., Ltd.: RIKEMAL S-100A)

### Evaluation Method

### (1) Spectral Light Transmittance

Pellets obtained from each composition of the examples were dried at 120° C. for 5 hours in a hot-air circulating dryer, and, using an injection molding machine [J85-ELIII manufactured by Japan Steel Works, Ltd.], at a molding temperature of 270° C. and a mold temperature of 80° C., formed into a molded plate having a width of 50 mm, a length of 90 mm, and a thickness of 2 mm. The spectral light transmittance of this 2-mm-thick molded plate was measured using a spectrophotometer [Cary 5000 manufactured by Agilent Technologies, Inc.] at intervals of 1 nm in a wavelength range of 200 nm to 800 nm. From the obtained spectral light transmittance, the average spectral light transmittance in a wavelength range of 340 nm to 420 nm was calculated.

The higher the value of the spectral light transmittance, the less the attenuation of light, indicating better light-guiding performance. A spectral light transmittance of 86.0% or more was rated as A, 85.5% or more and less than 86.0% was rated as B, and less than 85.5% was rated as F.

### (2) Molded Plate Hue

Pellets obtained from each composition of the examples were dried at 120° C. for 5 hours in a hot-air circulating dryer, and, using an injection molding machine [J85-ELIII manufactured by Japan Steel Works, Ltd.], at a molding temperature of 270° C. and a mold temperature of 80° C., formed into a molded plate having a width of 50 mm, a length of 90 mm, and a thickness of 2 mm. The hue (L*, a*, b*) of this 2-mm-thick molded plate was measured using an integrating sphere spectrophotometer [CE-7000A manufactured by X-Rite Inc.] in accordance with JIS-K7105 under the following conditions: light source: D65, viewing angle: 10°, transmission method.

The higher the b*-value of the molded plate is, the more likely the molded plate is to turn yellow. A b*-value of 0.4 or less was rated as A, and more than 0.4 was rated as F.

### (3) Moist Heat Resistance

Pellets obtained from each composition of the examples were dried at 120° C. for 5 hours in a hot-air circulating dryer, and, using an injection molding machine [J85-ELIII manufactured by Japan Steel Works, Ltd.], at a molding temperature of 270° C. and a mold temperature of 80° C., formed into a molded plate having a width of 50 mm, a length of 90 mm, and a thickness of 2 mm. This molded plate was subjected to a moist heat treatment (temperature: 120° C., 24 hours) using a steam sterilizer [SN-510 manufactured by Yamato Scientific Co., Ltd.], and the Hazes before the moist heat treatment and after the moist heat treatment and the viscosity average molecular weight (Mv) were measured. The Haze of the molded plate was measured in accordance with JIS-K7361-1, and the viscosity average molecular weight (Mv) was measured by the following method.

### Measurement of Viscosity Average Molecular Weight (Mv)

Using an Ostwald viscometer, the specific viscosity (η_{SP}) calculated by the following equation was obtained from a solution of a polycarbonate resin dissolved at 20° C. in 100 ml of methylene chloride, and, from the obtained specific viscosity (η_{SP}), the viscosity average molecular weight Mv was calculated by the following numerical expression.

$$Specific viscosity ( {η}_{SP} ) = ( t - {t}_{0} ) / {t}_{0}$$

[t₀ is the number of seconds taken for methylene chloride to fall, and t is the number of seconds taken for the sample solution to fall]

$${η}_{SP} / c = [ η ] + 0.45 \times {[ η ]}^{2} c ( wherein [ η ] is intrinsic viscosity )$$

$$[ η ] = 1.23 \times {10}^{- 4} {Mv}^{0.83}$$

$$c = 0.7$$

The higher the Haze after the moist heat treatment, the lower the transparency of the molded plate, and the greater the decrease in the viscosity average molecular weight after the moist heat treatment is, the more likely the resin is to be hydrolyzed. The increase in Haze before and after the moist heat treatment was expressed as ΔHaze. A ΔHaze of 1.0 or less was rated as A, and more than 1.0 was rated as F. In addition, the decrease in Mv before and after the moist heat treatment was expressed as ΔMv. A ΔMv of 1,000 or less was rated as A, and more than 1,000 was rated as F.

### Examples 1 to 10 and Comparative Examples 1 to 7

The component A, the component B, and other components were mixed in a blender in the respective incorporation amounts shown in Table 1, and then melt-kneaded using a vented twin-screw extruder to obtain pellets. As the vented twin-screw extruder, TEX30α (fully intermeshed, co-rotating, double-threaded screw) manufactured by Japan Steel Works, Ltd., was used. The extrusion conditions were as follows: discharge rate: 30 kg/h, screw rotation speed: 270 rpm, vent vacuum: 1 kPa. In addition, the extrusion temperature was 260° C. (when using component A-1) or 290° C. (when using component A-2). The evaluation results are shown in Table 1.

TABLE 1

| | | | | Exam- | Exam- | Exam- | Exam- | Exam- | Exam- | Exam- | Exam- | Exam- |
|---|---|---|---|---|---|---|---|---|---|---|---|---|
| | | | | ple 1 | ple 2 | ple 3 | ple 4 | ple 5 | ple 6 | ple 7 | ple 8 | ple 9 |
| Composition | Component A | A-1 | | 100 | 100 | 100 | | 100 | 100 | 100 | 100 | 100 |
| (part by wt) | | A-2 | | | | | 100 | | | | | |
| | Component B | B-1 | | 0.02 | 0.05 | 0.08 | 0.05 | | 0.05 | 0.05 | 0.05 | 0.05 |
| | | B-2 | | | | | | 0.05 | | | | |
| | Other | D-1 | | | | | | | | | | |
| | Components | D-2 | | | | | | | | | | |
| | | D-3 | | | | | | | | | 0.05 | 0.05 |
| | | E | | | | | | | 0.03 | 0.1 | 0.03 | 0.1 |
| Evaluation | (1) Spectral | % (340 nm-420 nm) | | 87.5 | 87.8 | 87.9 | 87.6 | 85.6 | 88.0 | 87.9 | 87.8 | 87.8 |
| | Light | Judgment:: A ≥ 86.0 | | A | A | A | A | B | A | A | A | A |
| | Transmittance | B ≥ 85.5 | | | | | | | | | | |
| | (2) Molded | b*-Value | | 0.34 | 0.34 | 0.34 | 0.34 | 0.39 | 0.35 | 0.35 | 0.35 | 0.35 |
| | Plate Hue | Judgment: A ≤ 0.4 | | A | A | A | A | A | A | A | A | A |
| | (3) Moist | Haze | Before | 0.1 | 0.1 | 0.1 | 0.1 | 0.1 | 0.1 | 0.1 | 0.1 | 0.1 |
| | Heat | (%) | treatment | | | | | | | | | |
| | Resistance | | After | 0.2 | 0.2 | 0.2 | 0.2 | 0.2 | 0.2 | 0.2 | 0.2 | 0.2 |
| | | | treatment | | | | | | | | | |
| | | | Δ | 0.1 | 0.1 | 0.1 | 0.1 | 0.1 | 0.1 | 0.1 | 0.1 | 0.1 |

| Judgment: A ≤ 1.0 | | A | A | A | A | A | A | A | A | A |
|---|---|---|---|---|---|---|---|---|---|---|
| Mv | Before | 15.3 | 15.3 | 15.3 | 19.9 | 15.2 | 15.3 | 15.2 | 15.2 | 15.2 |
| (×1000) | treatment | | | | | | | | | |
| | After | 15.0 | 15.1 | 15.0 | 19.7 | 15.0 | 15.0 | 15.0 | 15.0 | 15.0 |
| | treatment | | | | | | | | | |
| | Δ | 0.3 | 0.2 | 0.3 | 0.2 | 0.2 | 0.3 | 0.2 | 0.2 | 0.2 |

| | | | | | | | | | |
|---|---|---|---|---|---|---|---|---|---|
| Judgment: A ≤ 1.0 | A | A | A | A | A | A | A | A | A |

| | | | | | Compar- | Compar- | Compar- | Compar- | Compar- | Compar- | Compar- |
|---|---|---|---|---|---|---|---|---|---|---|---|
| | | | | | ative | ative | ative | ative | ative | ative | ative |
| | | | | Exam- | Exam- | Exam- | Exam- | Exam- | Exam- | Exam- | Exam- |
| | | | | ple 10 | ple 1 | ple 2 | ple 3 | ple 4 | ple 5 | ple 6 | ple 7 |
| Composition | Component A | A-1 | | 100 | 100 | | | 100 | 100 | 100 | |
| (part by wt) | | A-2 | | | | 100 | 100 | | | | 100 |
| | Component B | B-1 | | 0.01 | | | | | | | |
| | | B-2 | | | | | | | | | |
| | Other | D-1 | | 0.01 | | | | 0.02 | 0.05 | 0.08 | 0.05 |
| | Components | D-2 | | | | | 0.05 | | | | |
| | | D-3 | | | | | | | | | |
| | | E | | | | | | | | | |
| Evaluation | (1) Spectral | % (340 nm-420 nm) | | 87.4 | 82.9 | 82.9 | 84.4 | 87.3 | 87.7 | 87.9 | 86.8 |
| | Light | Judgment:: A ≥ 86.0 | | A | F | F | F | A | A | A | A |
| | Transmittance | B ≥ 85.5 | | | | | | | | | |
| | (2) Molded | b*-Value | | 0.35 | 0.50 | 0.48 | 0.41 | 0.35 | 0.33 | 0.33 | 0.36 |
| | Plate Hue | Judgment: A ≤ 0.4 | | A | F | F | F | A | A | A | A |
| | (3) Moist | Haze | Before | 0.1 | 0.1 | 0.1 | 0.1 | 0.1 | 0.1 | 0.1 | 0.1 |
| | Heat | (%) | treatment | | | | | | | | |
| | Resistance | | After | 0.2 | 0.3 | 0.2 | 0.3 | 4.3 | 79.3 | 89.9 | 71.2 |
| | | | treatment | | | | | | | | |
| | | | Δ | 0.1 | 0.2 | 0.1 | 0.2 | 4.2 | 79.2 | 89.8 | 71.1 |

| Judgment: A ≤ 1.0 | | A | A | A | A | F | F | F | F |
|---|---|---|---|---|---|---|---|---|---|
| Mv | Before | 15.3 | 15.4 | 19.9 | 19.9 | 15.4 | 15.4 | 15.4 | 19.9 |
| (×1000) | treatment | | | | | | | | |
| | After | 14.4 | 15.2 | 19.9 | 19.4 | 13.2 | 11.9 | 11.6 | 17.2 |
| | treatment | | | | | | | | |
| | Δ | 0.9 | 0.2 | 0.0 | 0.5 | 2.2 | 3.5 | 3.8 | 2.7 |

| | | | | | | | | |
|---|---|---|---|---|---|---|---|---|
| Judgment: A ≤ 1.0 | A | A | A | A | F | F | F | F |

### Mode 2

### Component A

A: Bisphenol A aromatic polycarbonate resin (manufactured by Teijin Limited: CM-1000, viscosity average molecular weight=15,400)

### Component B

B: Pentaerythritol tetrakis(3-laurylthiopropionate) (manufactured by Sumitomo Chemical Co., Ltd.: SUMILIZER TP-D)

### Component C

C-1: Polycaprolactone tetraol, number average molecular weight=1,000 (“PLACCEL 410” manufactured by Daicel Corporation)
C-2: Polycaprolactone triol, number average molecular weight=2,000 (“PLACCEL 320” manufactured by Daicel Corporation)
C-3: Polycaprolactone diol, number average molecular weight=1,000 (“PLACCEL 210” manufactured by Daicel Corporation)
C-4: Polycaprolactone diol, number average molecular weight=4,000 (“PLACCEL 240” manufactured by Daicel Corporation)

### Other Components

### Antioxidant

D: Hindered phenol-based antioxidant (manufactured by BASF: Irganox 1076)

### Release Agent

E: Glycerin monostearate (manufactured by Riken Vitamin Co., Ltd.: RIKEMAL S-100A)

### Evaluation Method

### (1) Spectral Light Transmittance

Pellets obtained from each composition of the examples were dried at 120° C. for 5 hours in a hot-air circulating dryer, and, using an injection molding machine [J85-ELIII manufactured by Japan Steel Works, Ltd.], at a molding temperature of 270° C. and a mold temperature of 80° C., formed into a molded plate having a width of 50 mm, a length of 90 mm, and a thickness of 2 mm. The spectral light transmittance of this 2-mm-thick molded plate was measured using a spectrophotometer [Cary 5000 manufactured by Agilent Technologies, Inc.] at intervals of 1 nm in a wavelength range of 200 nm to 800 nm. From the obtained spectral light transmittance, the average spectral light transmittance in a wavelength range of 340 nm to 420 nm was calculated.

The higher the value of the spectral light transmittance, the less the attenuation of light, indicating better light-guiding performance. A spectral light transmittance of 86.0% or more was rated as A, 85.5% or more and less than 86.0% was rated as B, and less than 85.5% was rated as F.

### (2) Molded Plate Hue

Pellets obtained from each composition of the examples were dried at 120° C. for 5 hours in a hot-air circulating dryer, and, using an injection molding machine [J85-ELIII manufactured by Japan Steel Works, Ltd.], at a molding temperature of 270° C. and a mold temperature of 80° C., formed into a molded plate having a width of 50 mm, a length of 90 mm, and a thickness of 2 mm. The hue (L*, a*, b*) of this 2-mm-thick molded plate was measured using an integrating sphere spectrophotometer [CE-7000A manufactured by X-Rite Inc.] in accordance with JIS-K7105 under the following conditions: light source: D65, viewing angle: 10°, transmission method.

The higher the b*-value of the molded plate is, the more likely the molded plate is to turn yellow. A b*-value of 0.4 or less was rated as A, and more than 0.4 was rated as F.

### (3) Moist Heat Resistance

Pellets obtained from each composition of the examples were dried at 120° C. for 5 hours in a hot-air circulating dryer, and, using an injection molding machine [J85-ELIII manufactured by Japan Steel Works, Ltd.], at a molding temperature of 270° C. and a mold temperature of 80° C., formed into a molded plate having a width of 50 mm, a length of 90 mm, and a thickness of 2 mm. This molded plate was subjected to a moist heat treatment (temperature: 120° C., 24 hours) using a steam sterilizer [SN-510 manufactured by Yamato Scientific Co., Ltd.], and the Hazes before the moist heat treatment and after the moist heat treatment and the viscosity average molecular weight (Mv) were measured. The Haze of the molded plate was measured in accordance with JIS-K7361-1, and the viscosity average molecular weight (Mv) was measured by the following method.

### Measurement of Viscosity Average Molecular Weight (Mv)

Using an Ostwald viscometer, the specific viscosity (η_{SP}) calculated by the following equation was obtained from a solution of a polycarbonate resin dissolved at 20° C. in 100 ml of methylene chloride, and, from the obtained specific viscosity (η_{SP}), the viscosity average molecular weight Mv was calculated by the following numerical expression.

$$Specific viscosity ( {η}_{SP} ) = ( t - {t}_{0} ) / {t}_{0}$$

[t₀ is the number of seconds taken for methylene chloride to fall, and t is the number of seconds taken for the sample solution to fall]

$${η}_{SP} / c = [ η ] + 0.45 \times {[ η ]}^{2} c ( where [ η ] is intrinsic viscosity )$$

$$[ η ] = 1.23 \times {10}^{- 4} {Mv}^{0.83}$$

$$c = 0.7$$

The higher the Haze after the moist heat treatment, the lower the transparency of the molded plate, and the greater the decrease in the viscosity average molecular weight after the moist heat treatment is, the more likely the resin is to be hydrolyzed. The increase in Haze before and after the moist heat treatment was expressed as ΔHaze. A ΔHaze of 1.5 or less was rated as A, and more than 1.5 was rated as F. In addition, the decrease in Mv before and after the moist heat treatment was expressed as ΔMv. A ΔMv of 1,000 or less was rated as A, and more than 1,000 was rated as F.

### Examples 11 to 18 and Comparative Examples 8 to 9

The component A, the component B, the component C, and other components were mixed in a blender at the respective incorporation amounts shown in Table 2, and then melt-kneaded using a vented twin-screw extruder to obtain pellets. As the vented twin-screw extruder, TEX30α (fully intermeshed, co-rotating, double-threaded screw) manufactured by Japan Steel Works, Ltd., was used. The extrusion conditions were as follows: discharge rate: 30 kg/h, screw rotation speed: 270 rpm, vent vacuum: 1 kPa. In addition, the extrusion temperature was 260° C. The evaluation results are shown in Table 2.

TABLE 2

| | | | | Exam- | Exam- | Exam- | Exam- | Exam- | Exam- |
|---|---|---|---|---|---|---|---|---|---|
| | | | | ple 11 | ple 12 | ple 13 | ple 14 | ple 15 | ple 16 |
| Composition | Component A | A | | 100 | 100 | 100 | 100 | 100 | 100 |
| | Component B | B | | 0.05 | 0.05 | 0.05 | 0.05 | 0.05 | 0.05 |
| | Component C | C-1 | | 1.0 | | | | 1.0 | 1.0 |
| | | C-2 | | | 1.0 | | | | |
| | | C-3 | | | | 1.0 | | | |
| | | C-4 | | | | | 1.0 | | |
| | Other | D | | | | | | 0.02 | 0.05 |
| | Components | E | | 0.03 | 0.03 | 0.03 | 0.03 | 0.03 | 0.03 |
| Evaluation | (1) Spectral | % (340 nm-420 nm) | | 87.8 | 87.1 | 87.8 | 87.7 | 87.4 | 87.8 |
| | Light | Judgment: A ≥ 86.0 | | A | A | A | A | A | A |
| | Transmittance | B ≥ 85.5 | | | | | | | |
| | (2) Molded | b*-Value | | 0.33 | 0.40 | 0.33 | 0.34 | 0.34 | 0.34 |
| | Plate Hue | Judgment: A ≤ 0.4 | | A | A | A | A | A | A |
| | (3) Moist | Haze | Before | 0.1 | 0.1 | 0.1 | 0.1 | 0.1 | 0.1 |
| | Heat | (%) | treatment | | | | | | |
| | Resistance | | After | 1.5 | 1.4 | 1.3 | 1.6 | 1.5 | 1.5 |
| | | | treatment | | | | | | |
| | | | Δ | 1.4 | 1.3 | 1.2 | 1.5 | 1.4 | 1.4 |

| Judgment: A ≤ 2.0 | | A | A | A | A | A | A |
|---|---|---|---|---|---|---|---|
| Mv | Before | 15.1 | 14.9 | 15.0 | 15.1 | 15.0 | 15.0 |
| (×1000) | treatment | | | | | | |
| | After | 14.4 | 14.7 | 14.6 | 14.7 | 14.3 | 14.4 |
| | treatment | | | | | | |
| | Δ | 0.7 | 0.2 | 0.4 | 0.4 | 0.7 | 0.6 |

| | | | | | | |
|---|---|---|---|---|---|---|
| Judgment: A ≤ 1.0 | A | A | A | A | A | A |

| | | | | | Compar- | Compar- |
|---|---|---|---|---|---|---|
| | | | | | ative | ative |
| | | | Exam- | Exam- | Exam- | Exam- |
| | | | ple 17 | ple 18 | ple 8 | ple 9 |
| Composition | Component A | A | 100 | 100 | 100 | 100 |
| | Component B | B | 0.01 | 0.15 | | |
| | Component C | C-1 | 1.3 | 0.5 | | 1.0 |
| | | C-2 | | | | |
| | | C-3 | | | | |
| | | C-4 | | | | |
| | Other | D | | | | |
| | Components | E | 0.03 | 0.03 | 0.03 | 0.03 |
| Evaluation | (1) Spectral | % (340 nm-420 nm) | 87.0 | 87.0 | 83.4 | 85.4 |
| | Light | Judgment: A ≥ 86.0 | A | A | F | F |
| | Transmittance | B ≥ 85.5 | | | | |
| | (2) Molded | b*-Value | 0.34 | 0.34 | 0.46 | 0.37 |
| | Plate Hue | Judgment: A ≤ 0.4 | A | A | F | A |

| | | | | | | |
|---|---|---|---|---|---|---|
| (3) Moist | Haze | Before | 0.1 | 0.1 | 0.1 | 0.1 |
| Heat | (%) | treatment | | | | |
| Resistance | | After | 1.9 | 0.8 | 0.6 | 1.5 |
| | | treatment | | | | |
| | | Δ | 1.8 | 0.9 | 0.5 | 1.4 |

| Judgment: A ≤ 2.0 | | A | A | A | A |
|---|---|---|---|---|---|
| Mv | Before | 15.0 | 15.0 | 15.2 | 15.0 |
| (×1000) | treatment | | | | |
| | After | 14.1 | 14.6 | 15.1 | 14.9 |
| | treatment | | | | |
| | Δ | 0.9 | 0.4 | 0.1 | 0.1 |

| | | | | |
|---|---|---|---|---|
| Judgment: A ≤ 1.0 | A | A | A | A |

### INDUSTRIAL APPLICABILITY

The polycarbonate resin composition of the invention has excellent light-guiding properties with less yellowing during molding and less degradation in a moist heat environment. Molded articles obtained from the polycarbonate resin composition are extremely useful for various industrial applications such as the lighting field including LED lights, the OA equipment field, the electrical and electronic equipment field, and the automotive field.

1. An area light source device comprising a polycarbonate resin composition having light-guiding performance,
wherein the polycarbonate resin composition having light-guiding performance, comprises, per 100 parts by weight of (A) a polycarbonate resin (component A), 0.005 to 0.2 parts by weight of (B) a thioether-based compound (component B), and 0.2 to 1.5 parts by weight of (C) a caprolactone-based polymer having a number average molecular weight of 300 to 8,000 (component C),
wherein the caprolactone polymer serving as component C is at least one caprolactone-based polymer selected from the group consisting of bifunctional polycaprolactone diols, trifunctional polycaprolactone triols, and tetrafunctional polycaprolactone tetraols represented by the following formulas [3] to [5]: 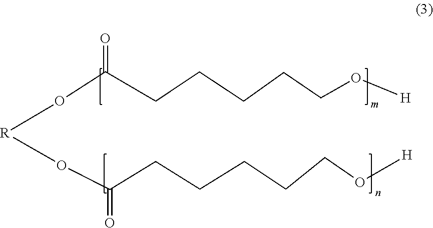
wherein m+n is an integer of 3 or more and 35 or less, and R is C₂H₄, C₂H₄OC₂H₄, or C(CH₃)₂(CH₂)₂; 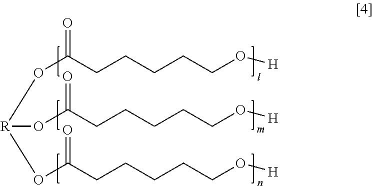
wherein l+m+n is an integer of 3 or more and 35 or less, and R is CH₂CHCH₂, CH₃C(CH₂)₃, or CH₃CH₂C(CH₂)₃; 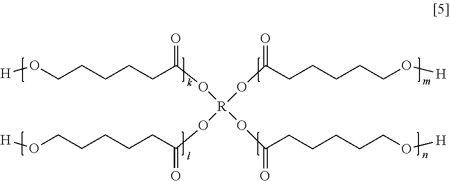
wherein k+l+m+n is an integer of 4 or more and 35 or less, and R is C(CH₂)₄.

2. The area light source device according to claim 1, further comprising a light source.

3. A light source device comprising a light source provided on at least one side surface of a molded plate obtained by molding a polycarbonate resin composition having light-guiding performance into a plate shape, and a reflection plate installed on one side of the molded plate,
wherein the light source device is an area light source device, and
wherein the polycarbonate resin composition having light-guiding performance, comprises, per 100 parts by weight of (A) a polycarbonate resin (component A), 0.005 to 0.2 parts by weight of (B) a thioether-based compound (component B), and 0.2 to 1.5 parts by weight of (C) a caprolactone-based polymer having a number average molecular weight of 300 to 8,000 (component C),
wherein the caprolactone polymer serving as component C is at least one caprolactone-based polymer selected from the group consisting of bifunctional polycaprolactone diols, trifunctional polycaprolactone triols, and tetrafunctional polycaprolactone tetraols represented by the following formulas [3] to [5]: 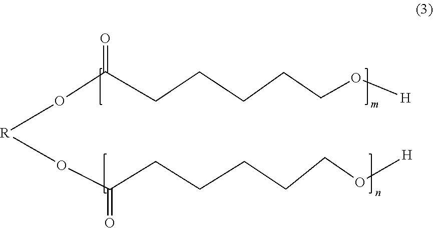
wherein m+n is an integer of 3 or more and 35 or less, and R is C₂H₄, C₂H₄OC₂H₄, or C(CH₃)₂(CH₂)₂; 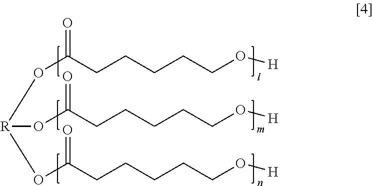
wherein l+m+n is an integer of 3 or more and 35 or less, and R is CH₂CHCH₂, CH₃C(CH₂)₃, or CH₃CH₂C(CH₂)₃; 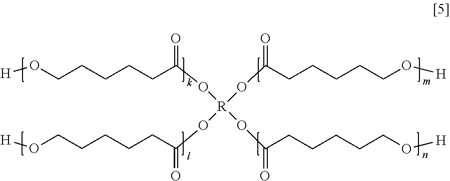
wherein k+l+m+n is an integer of 4 or more and 35 or less, and R is C(CH₂)₄.

4. The area light source device according to claim 1, wherein the thioether-based compound serving as component B is a thioether-based compound represented by the following formula [1] or [2]: 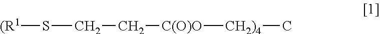
wherein each R¹, which may be the same or different, is a linear or branched C₄₋₂₀ alkyl group; 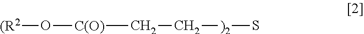
wherein each R², which may be the same or different, is a linear or branched C₆₋₂₂ alkyl group.

5. The area light source device according to claim 1, wherein the thioether-based compound serving as component B is at least one thioether compound selected from the group consisting of dilauryl-3,3′-thiodipropionate, dimyristyl-3,3′-thiodipropionate, distearyl-3,3′-thiodipropionate, and pentaerythritol tetrakis(3-laurylthiopropionate).

6. The area light source device according to claim 1, wherein the caprolactone polymer serving as component C has a number average molecular weight of 500 to 5,000.

7. The light source device according to claim 3, wherein the thioether-based compound serving as component B is a thioether-based compound represented by the following formula [1] or [2]: 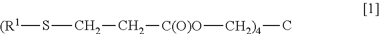
wherein each R¹, which may be the same or different, is a linear or branched C₄₋₂₀ alkyl group; 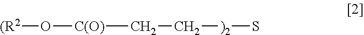
wherein each R², which may be the same or different, is a linear or branched C₆₋₂₂ alkyl group.

8. The light source device according to claim 3, wherein the thioether-based compound serving as component B is at least one thioether compound selected from the group consisting of dilauryl-3,3′-thiodipropionate, dimyristyl-3,3′-thiodipropionate, distearyl-3,3′-thiodipropionate, and pentaerythritol tetrakis (3-laurylthiopropionate).

9. The light source device according to claim 3, wherein the caprolactone polymer serving as component C has a number average molecular weight of 500 to 5,000.
